(19) United States
(12) Patent Application Publication
(10) Pub. No.: US 2005/0179799 A1
(43) Pub. Date: Aug. 18, 2005

(54) Firearm mounted video camera

(76) Inventors: Yuriy K. Umanskiy, Centennol, CO (US); Eugene Esayev, Aurora, CO (US); Maxim Troitski, Aurora, CO (US)

Correspondence Address: LEYENDECKER LEMIRE & DALEY, LLC, C/O PORTFOLIO IP P.O BOX 52057, MINNEAPOLIS, MN, 55402, US

(21) Appl. No.: 10/779,124

(22) Filed: Feb. 14, 2004

(51) Int. Cl. H04N 5/222

(52) U.S. Cl. 348/333.01

(57) ABSTRACT

A video camera mounted to a magazine of a semi-automatic handgun is described along with a weapon system incorporating the magazine-mounted video camera. In at least one embodiment, a small video camera is attached to a bottom plate of the ammunition magazine. The video camera is operatively coupled with a small portable video monitor that is carried or worn be the user. Accordingly, the user can use the firearm mounted camera to survey a scene while protected by a barrier or the user can use the video sighting system to survey a scene in no or low light situations.

### FIELD OF THE INVENTION

This invention generally relates to video sighting systems for firearms. More particularly, this invention pertains to a video camera mounted to a firearm permitting the user to view a scene and target the firearm using a monitor remotely located from the video camera and the firearm.

### BACKGROUND

Video targeting and monitoring apparatus for use with handheld and remotely located weapons are well known in the art. A remote visual weapon control system using a television camera mounted on the weapon for the purpose of remotely aiming the weapon was first described in U.S. Pat. No. 2,359,032. The described device comprises a video camera mounted on top of the barrel of a machine gun. The video camera is connected through wires to a television receiver on which a user can observe the scene in the vicinity of the remotely located machine gun. A remote trigger is also provided for firing the gun.

U.S. Pat. Nos. 4,786,966; 4,884,137; 4,970,589; and 5,200,827 all to Hanson et. al. and assigned to Varo, Inc. of Garland, Tex., describe a remote camera and video display system wherein the camera is mounted to the top of a firearm such as an assault rifle. The video display is incorporated into goggles that are typically attached to the wearer's helmet. The video is transmitted from the camera to the display through a wireless means. The size of the illustrated and described video camera along with the need to mount the camera on top of a firearm makes it unsuitable for use with semi-automatic or automatic handguns. Specifically, the top portion (or slide) of an automatic or semi-automatic handgun recoils rearwardly during firing to facilitate the discharge of the spent shell casing. Mounting a camera to the slide would: hinder the proper operation of the handgun; throw off the balance and center of gravity of the handgun making it more difficult to accurately aim; and subject camera to significant and potentially damaging loads during recoil.

Handheld firearms having a video camera attached thereto enable a user to determine the position of a combatant from behind a protective structure by simply extending the firearm over or around the protective structure without exposing the user's body to potential return fire. Further, the user can use the video images to target a combatant and fire the weapon without exposing anymore than his arm and hand to return fire. Another advantage of firearm-mounted video systems is that they permit a user to “see” in the dark since video cameras that are infrared sensitive can be utilized in low or no light situations in conjunction with infrared illuminators.

U.S. Pat. No. 5,834,676 describes a weapon mounted video camera with a video monitor mounted in or on a pair of goggles. In the illustrations accompanying the patent, the camera is shown mounted to the top of a semi-automatic handgun. However, there is no description in the patent concerning how the camera is mounted to the top portion of the handgun, nor is there any discussion concerning how the problems relating to mounting a camera on top of a semi-automatic handgun have been overcome. Rather, this patent directed primarily to a means for providing targeting cross hairs in the video image to assist a user in aiming the handgun and does not concern itself with issues relating to the placement or mounting of the video camera on the handgun.

Several companies, such as Arion International, Inc. of Melbourne, Fla., produce and market video camera systems that mount under the barrel on an accessory rail of a semi-automatic handgun. Unfortunately, not all semi-automatic handguns include accessory rails underneath the barrel, so these products are only applicable to certain handguns. There are several disadvantages to mounting the camera in this location. First, the lens of the camera is located in relatively close proximity to the end of the barrel. Accordingly, the lens tends to become contaminated rather quickly by powder residues resulting from the firing of the handgun. Additionally, the camera moves the handgun's center of gravity forward throwing off the handgun's balance and making the weapon more difficult to accurately aim and fire. Finally, when one of these cameras is mounted on the accessory rail, a user cannot mount a laser sight or other accessory to the rail or to the front of the trigger guard.

For purposes of this disclosure, all of the prior art patent references disclosed in this section are hereby incorporated by reference in their entirety.

### SUMMARY OF THE INVENTION

One embodiment of the present invention comprises a magazine of either a semi-automatic or automatic firearm in combination with a video camera wherein the video camera being mounted to the magazine.

Another embodiment of the present invention comprises a weapon system. The weapon system includes either an automatic or semi-automatic firearm; a magazine adapted for receipt into a handle of the firearm; and a video camera that is mounted to the magazine.

Yet another embodiment of the present invention also comprises a weapon system. The weapon system includes either an automatic or semi-automatic handgun and also includes a first accessory device. The handgun has a handle with a bottom side. The accessory device is either a laser sight, a video camera or a flashlight that is attached to the bottom side of the handle.

### SUMMARY OF THE DRAWINGS

FIG. 1 is an isometric view of one embodiment of the present invention wherein the video camera and the video monitor are coupled via electrical cables.

FIG. 2 is an isometric view of another embodiment of the present invention wherein the video camera and a heads up video display are coupled wirelessly.

FIG. 3 is an exploded isometric view of a typical semi-automatic handgun ammunition magazine.

FIG. 4 is an exploded isometric view of a modified semi-automatic handgun ammunition magazine and an associated video camera according to one embodiment of the present invention.

### DETAILED DESCRIPTION

Embodiments of the present invention comprise a video camera mounted to the magazine of a semi automatic or automatic handgun, and associated components for a firearm mounted video sighting system. In a typical preferred embodiment of the invention, a relatively small video camera is mounted to the bottom end of a cartridge magazine that is received into a cavity in the handle of an automatic or semi automatic handgun.

Embodiments of the present invention offer several significant advantages over prior art handgun and firearm mounted video cameras and video camera sighting systems. First, the video camera is easily attachable and removable from the handgun by simply changing out a standard magazine for a magazine having the video camera mounted thereto. Second, the camera is easily mounted on handguns not having an accessory rail. Further, because the lens of the video camera is located a substantial distance from the end of the gun's barrel, the risk of lens contamination is greatly reduced. Additionally, the area beneath the barrel and in front of the trigger guard remains open for use in mounting other types of accessories to the handgun, such as a laser sight or a flashlight. Finally, because the video camera is mounted underneath the grip of a handgun, the camera does not appreciably negatively affect the center of gravity or balance of the weapon, thereby making the weapon easier to aim and hold steady during discharge.

Numerous variations of the embodiments of the video camera and the video system are contemplated. For instance, certain variations include wireless transmitters and receivers such that the video display and the camera need not be physically connected. And in other variations, the monitor and the camera are connected via a transmission cable and an intervening battery pack and video controller. In one variation of the preferred embodiment, the monitor comprises an active-matrix TFT LCD screen, which can be worn by the user on his/her wrist. In another variation, a heads up video display may be integrated into a pair of goggles or glasses.

The advantages of the present invention and its various embodiments and the specific embodiments illustrated in described herein are not intended to be construed as limiting. Rather, numerous variations have been contemplated that read upon the appended claims and are intended to be within the scope of the invention.

Terminology

The term “or” as used in this specification and the appended claims is not meant to be exclusive rather the term is inclusive meaning “either or both”.

References in the specification to “one embodiment”, “an embodiment”, “a preferred embodiment”, “an alternative embodiment” and similar phrases means that a particular feature, structure, or characteristic described in connection with the embodiment is included in at least an embodiment of the invention. The appearances of the phrase “in one embodiment” in various places in the specification are not necessarily all referring to the same embodiment.

The term “couple” or “coupled” as used in this specification and the appended claims refers to either an indirect or direct connection between the identified elements, components or objects. Often the manner of the coupling will be related specifically to the manner in which the two coupled elements interact. For example, two elements are electrically coupled if electrical current can travel from one element to another even if the elements are not directly connected to one another but rather by way of a wire or other electrically conductive trace. Further, two elements can be operatively coupled if they are in communication with each other. For example, a wireless transmitter can be operatively coupled to a wireless receiver if signals are sent from the transmitter to the receiver.

Unless otherwise specifically indicated, the term “firearm” refers to any weapon carried by a person that is designed to fire a projectile.

The terms “handgun” and “pistol” are used interchangeably herein.

The terms “video display” and “video monitor” are used interchangeably herein.

### A FIRST PREFERRED EMBODIMENT

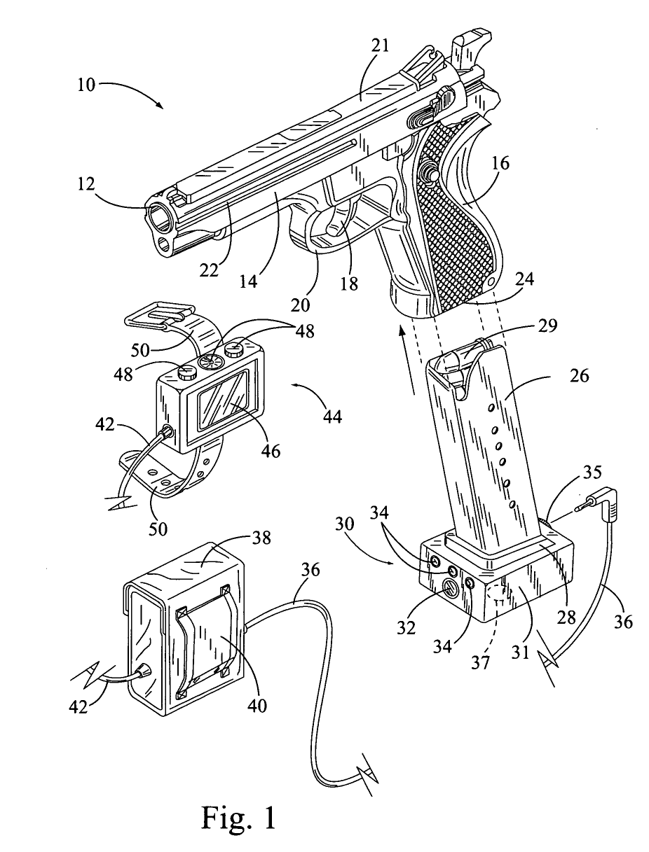

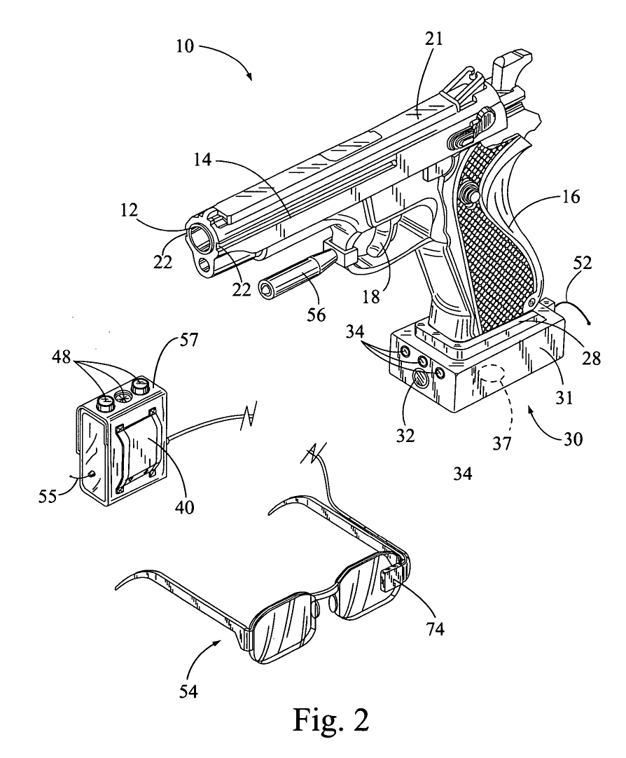

A first preferred embodiment of the present invention is illustrated in FIG. 1 in conjunction with a semi-automatic handgun 10. A typical semi-automatic handgun comprises a barrel 12 mounted on a frame 14 that includes a grip (or handle) 16. The top portion of a typical semi automatic handgun comprises a sliding member that is known in the art as a slide 21. When the handgun is fired, the slide recoils rearwardly to facilitate the ejection of a spent cartridge. Because of the dynamic nature of the slide, it is an unsuitable location to mount accessories, such as a not limited to laser sights, flashlights and video cameras. To facilitate the attachment of accessories to the handgun, a number of manufacturers provide accessory rails 22 on the portion of the frame in front of the trigger 18 and underneath the barrel. Additionally, accessories, such as laser sights and flashlights, are in many cases mounted to the trigger guard 20 (see FIG. 2 for example). In most automatic in semi-automatic handguns, a vertically extending cavity 24 is provided in the grip to receive a magazine 26 containing multiple rounds of ammunition 29 therein.

The video camera system of the first preferred embodiment typically comprises a modified magazine 26, the video camera 30 mounted to the magazine, a video controller and power pack (contained in a pouch 38 in FIG. 1), a video monitor 44 and associated electrical cables 36 and 42 to provide electrical power to the various components and to provide for the transmission of the video signals.

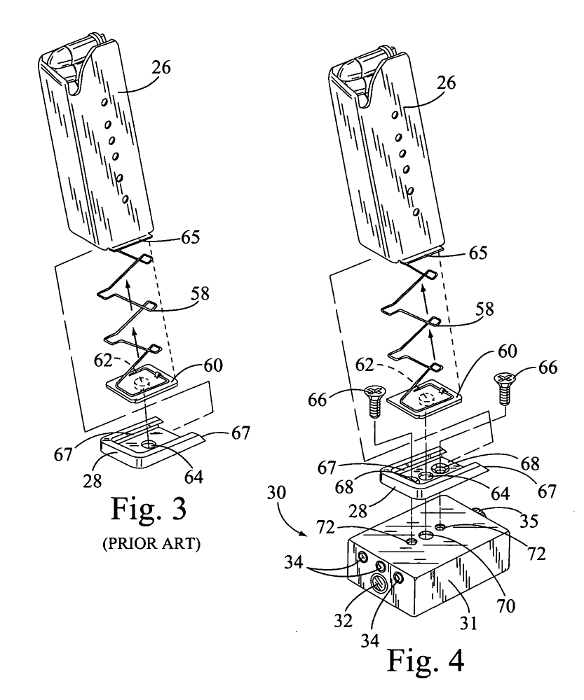

The modified magazine 26 is best described with reference to FIGS. 3 and 4. FIG. 3 is a depiction of a typical unmodified prior art magazine that includes a magazine chamber for holding multiple rounds of ammunition, a spring 58 for biasing the ammunition upwardly to facilitate the chambering of a round during operation of the handgun 10, and a bottom plate 28. The bottom end of the spring typically includes a spring end plate 60 that includes a cylindrical downwardly extending nubbin (or protrusion) 62. The bottom end of the magazine chamber is splayed outwardly to form left and right flanges 65. The flanges correspond with left and right slots 67 formed in the bottom plate such that the bottom plate is fixed into place at the bottom of the magazine chamber by sliding the slots of the bottom plate over the flanges of the magazine chamber. The cylindrical nubbin is received and biased into a nubbin hole 64 located in the bottom plate, thereby preventing the bottom plate from sliding off of the flanges.

Referring to FIG. 4, the modified magazine of the preferred embodiment differs from the prior art magazine of FIG. 3 only in regard to the bottom plate 28. Specifically, the bottom plate includes two or more holes 68 through which fasteners 66 are received to secure the housing 31 of the video camera 30 to the bottom plate. When a video camera is secured to the modified bottom plate, attaching the bottom plate to the magazine chamber also secures the video camera to the magazine 26. Accordingly, the video camera is attached to an associated handgun 10 by simply swapping a prior art magazine for a modified magazine with the video camera attached thereto.

Concerning the mounting of a video camera 30 to a magazine 26 of a semi-automatic handgun 10, there is a small amount of play between the magazine and the handgun, as well as, a small amount of play between the magazine and the magazine bottom plate. While this play can potentially affect the ability of a user to accurately target persons or objects at long distances from the handgun using the video sighting system, the system has proven to be relatively accurate at close-in distances of around 20 feet. Considering that handguns are primarily utilized in close range situations, the play associated with mounting the video camera 30 to the magazine 26 has not been found to be a detractor to the usefulness of the video sighting system of the preferred embodiment. Further, when the video sighting system is combined with a laser sight, a user can accurately target using the system at much greater distances.

The imager (not shown) of the video camera 30 typically comprises a relatively small CCD and associated circuitry combined with an optical lens 32 that is spaced and fixed a set distance from the CCD. The imager is contained in the associated housing 31. In one variation of the preferred embodiment, the imager is a black-and-white CCD. One type of CCD found to be suitable for use in the video camera is made by Sony and incorporates Ex-View™ technology. The CCD is sensitive in both daylight and low light situations. While black and white imagers are preferred in many situations because of their inherent low light capability and greater relative resolution, imagers having color filter arrays can also be utilized in variations of the preferred embodiment and in alternative embodiments. Further, imagers utilizing different capture technologies, such as but not limited to CMOS sensors, can be utilized as well.

For simplicity and lower cost, a fixed focus and fixed field of view lens 32 is typically utilized in the preferred embodiment. The lens is typically comprised of glass or an optical plastic. The lens and imager are typically configured to provide a depth of field from about a foot in front of the lens to infinity. In one variation, the field of view of the imager and lens combination is about 78 degrees; however, cameras with different fields of view can be utilized. Given that handguns are typically utilized in short range situations and a user typically desires to survey a particular scene as quickly as possible, lens and imager combinations giving a field of view of at least 40 degrees are preferred, at least 55 degrees are more preferred, and at least 70 degrees are most preferred. However, lens and imager combinations providing fields of view in excess of 80 degrees are less desirable as the amount of distortion can increase to levels that hinder a user's ability to target using the system.

The housing 31 of the video camera 30 encloses and protects the electronic circuitry of the imager and couples to the bottom plate 28 of the magazine 26. The housing can be comprised of any suitable material such as a metal or plastic. The top side of the housing includes three openings 70 and 72. The center opening 70 is provided to permit the nubbin 62 of a spring end plate 60 to pass therethrough. The two other openings 72 are threaded to receive the fasteners 66 utilized to secure the magazine bottom plate 28 to the camera. While the video camera is attached to the magazine bottom plate via screw-type fasteners in the preferred embodiment, in variations thereof and alternative embodiments the camera can be attached to the magazine bottom plate in any suitable manner, such as adhesive bonding, riveting, and integrally forming the magazine bottom plate with the video camera housing.

It is to be appreciated that to remove a magazine bottom plate 28 from the remainder of a magazine 26, a user must first depress the nubbin 62 of the spring's end plate 60 out of the nubbin opening 64 in the bottom plate so that the bottom plate can be slid forward along flanges 65 of the magazine. Accordingly, an opening 37 is provided on the bottom side of the video camera housing 31 through which a pencil, screwdriver or other elongated object can pass through to the opening 70 on the top side of the housing to depress the nubbin out of the bottom plate nubbin opening. It is appreciated in some variations, openings, such as openings 64, 70 & 34, to either receive the spring plate nubbin or provide access to the nubbin may be omitted. In such variations, the biasing pressure provided by the spring plate 60 against the bottom plate 28 is sufficient to hold the bottom plate and its attached camera in place.

A jack 35 is provided on the backside of the camera housing 31 for the purposes of connecting an electrical cable 36 thereto. In addition to the lens 32 on the front side of the housing, some variations of the preferred embodiment provide illuminators 34. The illuminators can be of any suitable type but typically comprise LEDs. In one variation, infrared LED illuminators are utilized that permit the camera to see in the dark but do not give off much if any visible light that would attract attention to the handgun and its user.

Referring back to FIG. 1, the video camera is connected to a video controller and associated battery pack by way of the electrical cable 36. Typically, the battery pack and controller are contained within a pack or other carrying case, such as the illustrated pouch 38, to be carried by the user of the associated handgun 10. As shown in FIG. 1, the illustrated pouch includes a belt clip 40 so that the video controller and battery pack can be attached to the user's belt. A second electrical cable 42 extends from the battery pack and controller to a video monitor 44.

The video controller primarily acts to process the image signal received from the video camera 30, transform the signal into a format usable by the video monitor 44 for display to the user. In variations of the preferred embodiment, the video controller can also be utilized to generate an electronic sighting reticle or other markings that are superimposed over the video images to assist the user in targeting. The location of the reticle can be adjusted to appear in various locations on the monitor. In other variations of the preferred embodiment and in alternative embodiments, the video controller may be integrated with one of the video monitor and the video camera thereby eliminating the need for the video controller circuitry to be housed in a separate pack or carrying case. Further, the batteries or other power source necessary for the operation of the monitor and video camera can be contained within each of these components.

The video monitor 44 illustrated in FIG. 1 typically comprises an active matrix TFT LCD screen 46. In the preferred embodiment, a 1.8″ diagonal color screen is utilized, although different types and sizes and screens can be used in variations. Typically, controls 48 in the form of buttons, dials, and switches are provided on the monitor to permit the user to adjust the monitor for his/her viewing preferences. As shown, the monitor includes a wrist strap 50 to permit the user to wear the monitor on his/her arm.

### A SECOND PREFERRED EMBODIMENT

A second preferred embodiment of the present invention in conjunction with a semi-automatic handgun 10 is illustrated in FIG. 2. The manner in which the video camera 30 is attached to the handgun is substantially similar to that of the first preferred embodiment. Unlike the video camera of the first preferred embodiment, the video camera of the second preferred embodiment includes a self-contained power supply and a wireless transmitter for transmitting the video signals to a video controller 57 and/or directly to a heads up video display 74, such as the one illustrated. An antenna 52 may extend from the video camera housing in certain variations. Because the power supply and a wireless transmitter are contained within the housing of the second preferred embodiment video camera, this video camera is typically somewhat larger than the video camera of the first preferred embodiment.

The heads up video display 74 of a second preferred embodiment is incorporated into a pair of glasses 54, thereby permitting a user to view the images from the video camera while simultaneously watching the scene around him/her. As illustrated, a power supply and video controller 57, which also includes a wireless receiver, are provided that can be carried by a user in his/her shirt pocket or attached to his/her belt. Controls and switches 48 can be provided to permit the user to adjust the video displayed on the heads up display. Additionally, an antenna 55 may extend from the wireless receiver in certain variations. In variations of the heads up video display

Also illustrated In FIG. 2 is a laser sight 56 attached to the front of the handgun's trigger guard 20. Alternatively, the laser sight can be attached with appropriate mounting hardware to the handgun's accessory rail 22. The laser sight whether a visual wavelength laser or an infrared wave length laser acts to improve a user's ability to accurately target using the video sighting system at greater distances in all lighting conditions. Further, other types of devices, such as a flashlight, can be attached to the handgun in the region below the handgun's barrel 12 and in front of the trigger guard.

### ALTERNATIVE EMBODIMENTS AND OTHER VARIATIONS

The embodiments of the firearm mounted video camera device and system as illustrated in the accompanying figures and described above are merely exemplary and are not meant to limit the scope of the invention. It is to be appreciated that numerous variations to the invention have been contemplated as would be obvious to one of ordinary skill in the art with the benefit of this disclosure. All variations of the invention that read upon the appended claims are intended and contemplated to be within the scope of the invention.

While the preferred embodiments have been described with respect to a semi-automatic handgun and concerning the mounting of the handgun to the magazine of such a firearm, in alternative embodiments, the camera could be mounted directly to the bottom of a grip of a pistol, such as a revolver, that does not utilize a magazine of the type specifically described above. Further, in other alternative embodiments, other types of accessories, such as flashlights and laser sights, can be mounted to the bottom of a handgun's grip and/or magazine, wherein another accessory, such as a video camera, can be mounted to the handgun in the region underneath the barrel and in front of the trigger guard.

Further, it is to be appreciated that numerous variations to the preferred embodiments are contemplated. For instance, in a hybrid of the first and second preferred embodiments, the video camera can be tethered via an electrical cable to the video controller but the video controller can be configured to transmit video signals to the monitor through a wireless connection. Vice versa the video camera can be wirelessly coupled with the video controller and the video controller can be tethered to the monitor via an electrical cable. Additionally, the specific manner in which one or both of the video controller pack and the video monitor are attached to the user can vary significantly in any of the embodiments.

The actual components utilized in the video camera, the video monitor and the video controller can vary substantially as well. For instance, a color CCD can be utilized in place of a black-and-white CCD, or an imaging device that is particularly adept an imaging infrared radiation may be interchanged with an imaging device that is optimized for visual wavelengths depending on a particular intended use of a particular video sighting system. In other embodiments, the lens assembly can be a zoom-type lens with or without an autofocus capability. A zoom lens can be controlled electronically via buttons or switches located on the monitor or video controller. In yet another embodiment, a wireless transmitter may be utilized to transmit the video signal to a remote location, such as a central command for a particular tactical operation. Finally, various adjustment mechanisms can be provided to fine tune the aim of the imager in the video camera housing so that it coincides with the barrel of the handgun. For example, the adjustment mechanisms may include screws the can make fine adjustments to the vertical and horizontal aim of the imager. In other variations, the imager may be mounted on a sliding platform within the housing that can be locked in place via set screws.

1. A magazine of one of a semi-automatic and automatic firearm in combination with a video camera, the video camera being mounted to the magazine.

2. The magazine and video camera combination of claim 1, wherein the combination is integrally removable from the one of the semi-automatic and automatic firearm.

3. The combination of claim 1, wherein the magazine is a magazine of a pistol.

4. The combination of claim 1, further comprising a video monitor, the video monitor being remotely located from the video camera.

5. The combination of claim 4, further including a control system and battery pack.

6. The combination of claim 4, wherein the video monitor and the video camera are coupled by way of an electrical cable.

7. The combination of claim 1, wherein the video camera includes one or more infrared illuminators.

8. The combination of claim 4, wherein the video camera includes a wireless transmitter and the monitor includes a wireless receiver.

9. The combination of claim 4, wherein the monitor is adapted to mount on the wrist of a user.

10. The combination of claim 1, wherein the video camera is mounted to a bottom end of the magazine.

11. The combination of claim 1, wherein in the magazine is adapted for receipt into a handle of the firearm.

12. A weapon system comprising:
one of an automatic and semi-automatic firearm;
a magazine adapted for receipt into a handle of the firearm; and
a video camera, the video camera being mounted to the magazine.

13. The weapon system of claim 12, further comprising a video monitor, the video monitor being coupled with the video camera.

14. The weapon system of claim 13, further comprising a controller, the controller adapted to process a first video signal from the video camera and transmit a second video signal to the monitor, the controller being coupled with the video camera and the monitor.

15. The weapon system of claim 14, wherein the controller is adapted to generate a targeting image to be displayed on the monitor.

16. The weapon system of claim 12, further comprising a laser sight, the laser sight being mounted to the firearm.

17. The weapon system of claim 12, wherein the firearm is a handgun.

18. A weapon system comprising:
one of an automatic and semi-automatic handgun, the handgun including a handle with a bottom side; and
a first accessory device comprising one of a laser sight, a video camera and a flashlight attached to the bottom side of the handle.

19. The weapon system of claim 18, further comprising a second accessory device comprising one of a laser sight, a video camera and a flashlight attached to at least one of an accessory rail, a frame and a trigger guard of the handgun.

20. The weapon system of claim 18, wherein the first accessory is a video camera and the video camera is attached to an ammunition magazine of the handgun.
